(19) United States
(12) Patent Application Publication
(10) Pub. No.: US 2021/0319388 A1
(43) Pub. Date: Oct. 14, 2021

(54) ACCOUNTABILITY TRACKING SYSTEM

(71) Applicant: JEREMY BYRD, MT. JULIET, TN (US)

(72) Inventor: JEREMY BYRD, MT. JULIET, TN (US)

(21) Appl. No.: 17/230,690

(22) Filed: Apr. 14, 2021

Related U.S. Application Data
(60) Provisional application No. 63/009,849, filed on Apr. 14, 2020.

(51) Int. Cl. G06Q 10/06; G06Q 10/10

(52) U.S. Cl. CPC G06Q 10/063114; G06Q 10/1091

(57) ABSTRACT

A system and application for maintaining and tracking accountability by users. The system allows a user to create and assign one or more tasks, actions, or objectives to one or more other users, receive information or confirmation from said one or more other users of a status or completion of a particular task, action, or objective, and respond thereto, if necessary. In several embodiments, two or more users may jointly send and/or receive information or confirmation about the status or completion of a particular task, action or objective, thereby providing accountability among the group of users. The particular task, action or objective may be assigned, performed or accomplished by a single individual, by members of a group individually, and/or by members of group together.

This application claims benefit of U.S. Provisional App. No. 63/009,849, filed Apr. 14, 2020, the complete disclosure of which is incorporated herein in its entirety by specific reference for all purposes.

### FIELD OF INVENTION

This invention relates to a system and methods for maintaining and tracking accountability by one or more users.

### BRIEF DESCRIPTION OF THE DRAWINGS

FIG. 1 shows a diagram of a system in accordance with an exemplary embodiment of the present invention.

FIGS. 2-4 show examples of task completion proof messages.

FIGS. 5-9 show diagrams of specific implementations of the system of FIG. 1.

### DETAILED DESCRIPTION OF EXEMPLARY EMBODIMENTS

In various exemplary embodiments, the present invention comprises a system and related methods for maintaining and tracking accountability by users. The system allows a user to create and assign one or more tasks, actions, or objectives to one or more other users, receive information or confirmation from said one or more other users of a status or completion of a particular task, action, or objective, and respond thereto, if necessary. In several embodiments, two or more users may jointly send and/or receive information or confirmation about the status or completion of a particular task, action or objective, thereby providing accountability among the group of users. The particular task, action or objective may be assigned, performed or accomplished by a single individual, by members of a group individually (i.e., one or more members of the group accomplish or work towards individual tasks, actions or objectives), and/or by members of group together (i.e., one or more members of the group accomplish or work towards group tasks, actions or objectives in concert or collectively).

In several embodiments, the system comprises a computer or mobile computing device application, programmed to transmit messages and data as described below. The application also may integrate pictures, videos, message services, location services, task lists, time stamps, notifications, and social media.

The present system may be used in a variety of situations, such as addiction recovery (e.g., monitoring and tracking of user accountability in drug and/or alcohol addiction and recovery programs), parenting/family (e.g., creating task lists for children or family members), employment (e.g., assigning work tasks to employees; confirming employee presence at remote sites), religious activities (e.g., sending requests for volunteer or community work), fitness and health (e.g., establishing that workouts were done), and court-ordered programs (e.g., establishing compliance with breathalyzer tests).

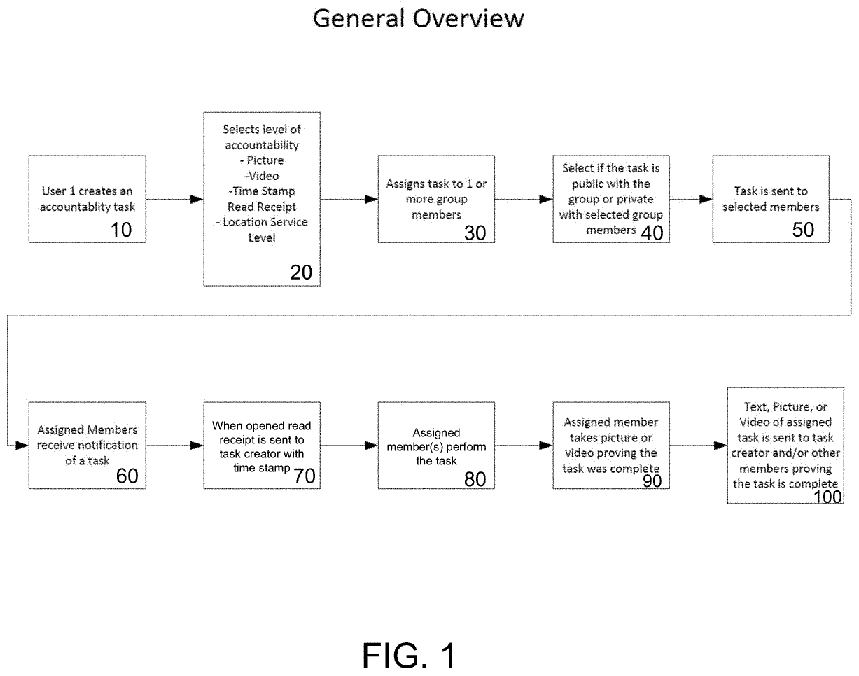

FIG. 1 provides a general overview of the operation of the system. A user creates an accountability task 10, specifying the task and level of accountability (e.g., frequency, location, individuals to perform the task, individuals to be notified of completion of the task), and the type of accountability/completion proof required (e.g., picture, video, read receipt, time stamp, location, service, level) 20. The task is assigned 30 to one or more group members. The user may select if the task is public within the group (i.e., available to all group members), or private (i.e., available or shared only with selected group members) 40.

The system then sends the task or a notification of the task to one or more of the selected group members or all group members 50. The members receive 60 the notification, and when opened, a time-stamped read receipt 70 is sent back to the creator. The member (or members) assigned to perform the task does so 80, takes a picture and/or video during performance of the task proving the task was completed 90, and sends the picture and/or video and/or other proof of task completion. to the task creator, other members of the group (which may be the entire group or just members participating in the particular task), and/or one or individuals designated to receive notification(s) of completion of the task 100. The proof of task completion may include one or more pictures, videos, text messages, location indicator, task description, task frequency (e.g., once, the specific number in a sequence, or the like), and time stamp.

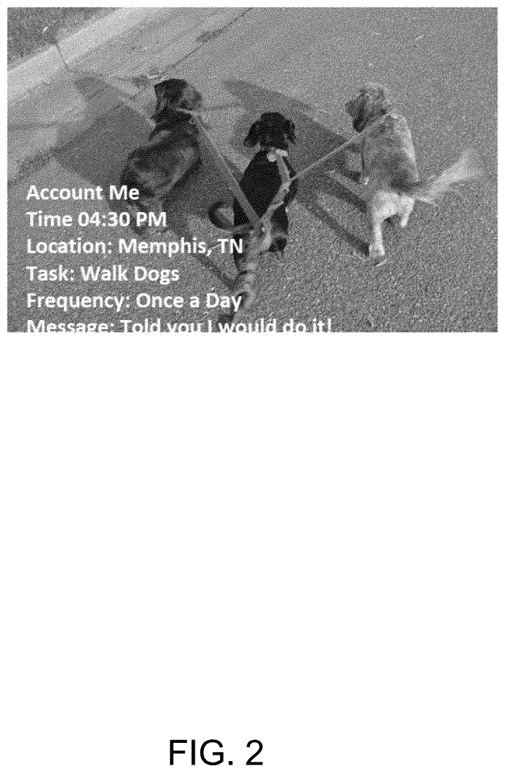

FIGS. 2-4 show examples of the proof of completion for various tasks.

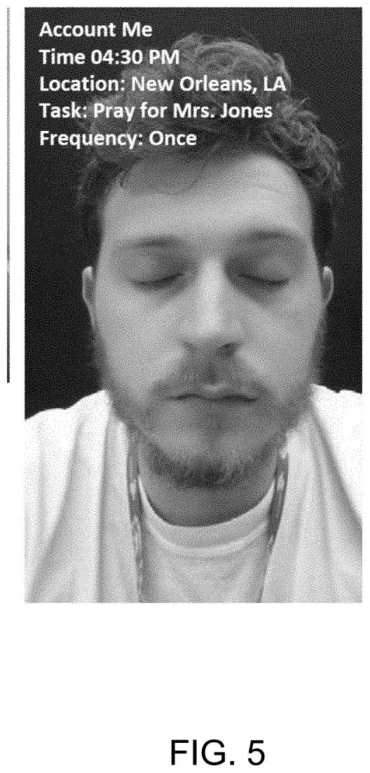

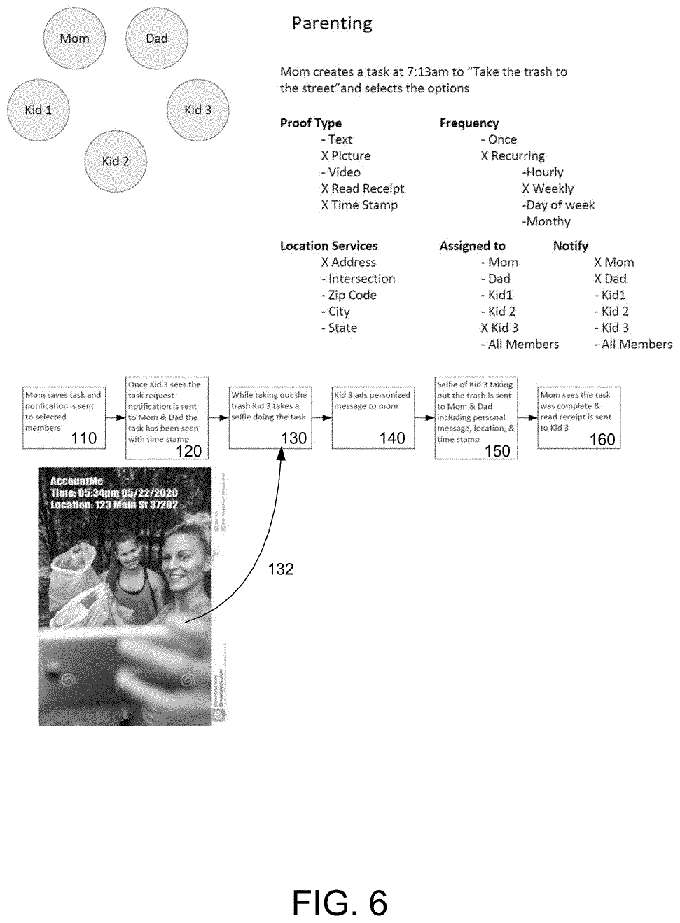

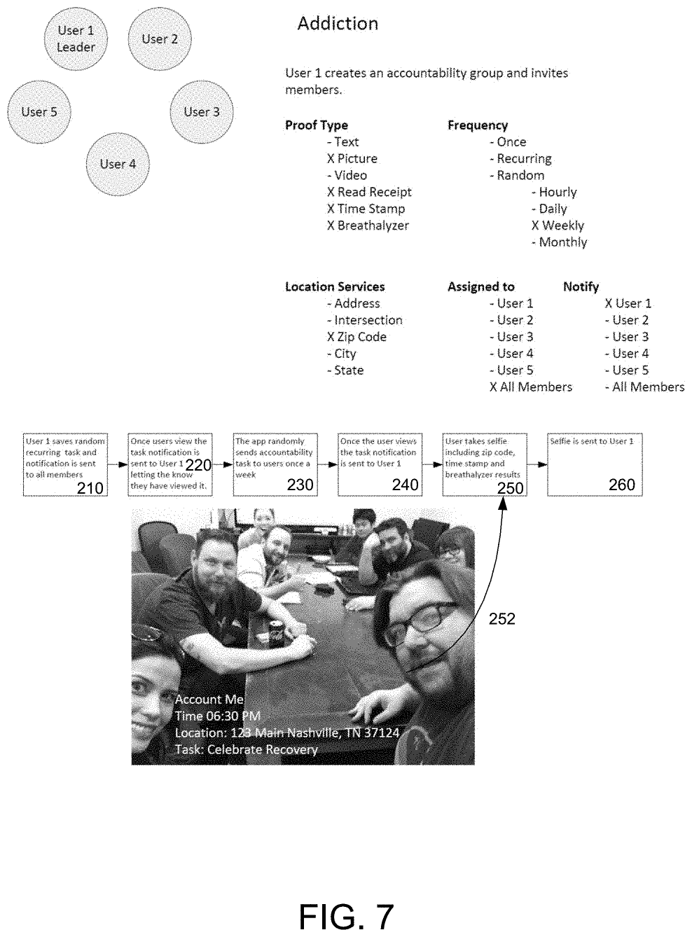

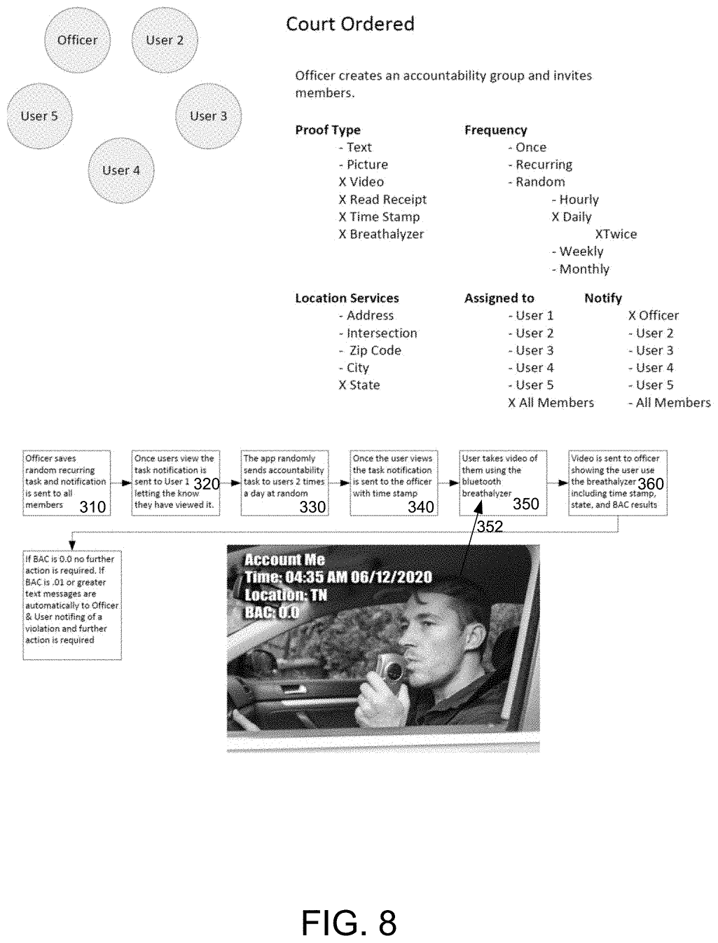

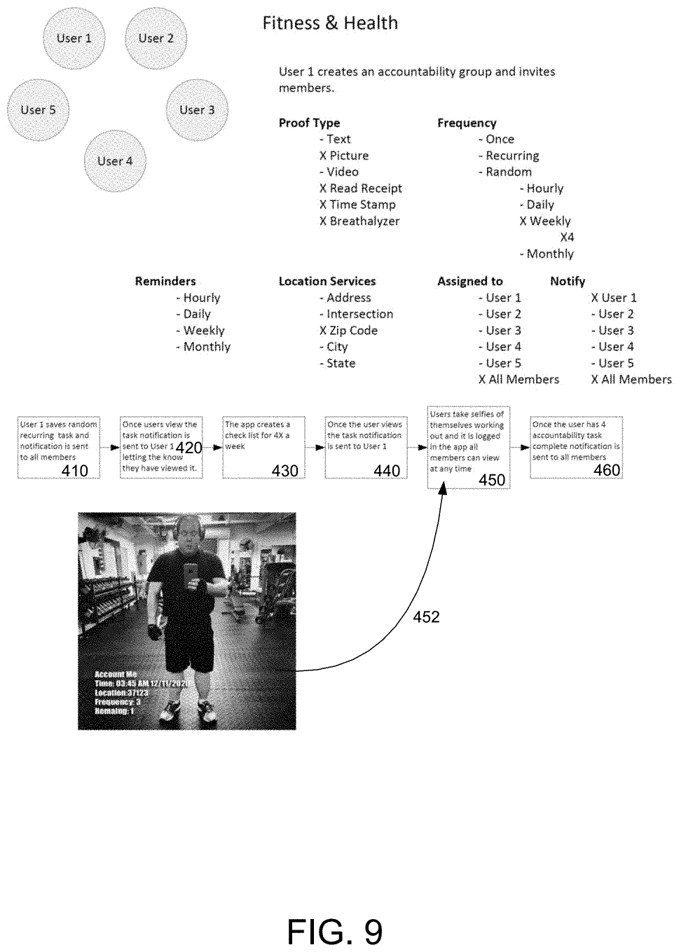

As seen in FIG. 5, in one exemplary embodiment a mother creates a task, specifying the frequency, location, individuals to perform the task, individuals to be notified of completion of the task, and the type of completion proof required (e.g., picture or video, read receipt, time stamp). The system then sends a notification to selected family members 110. The family member to perform the task (e.g., “Kid 3”) confirms that task has been received (with a time stamp) 120, performs the task 130, takes a “selfie” 130 during performance of the task, adds a personalized message 140, and sends the task completion confirmation to the person or persons to receive notification (e.g., mother and father, creator, or the like) 150, which may include a personal message, location and time stamp. The person receiving the notification/confirmation of completion (e.g., mother) sees the task was completed, and the system sends a read receipt 160 to the family member performing the task as acknowledgment that the task completion confirmation has been received and read.

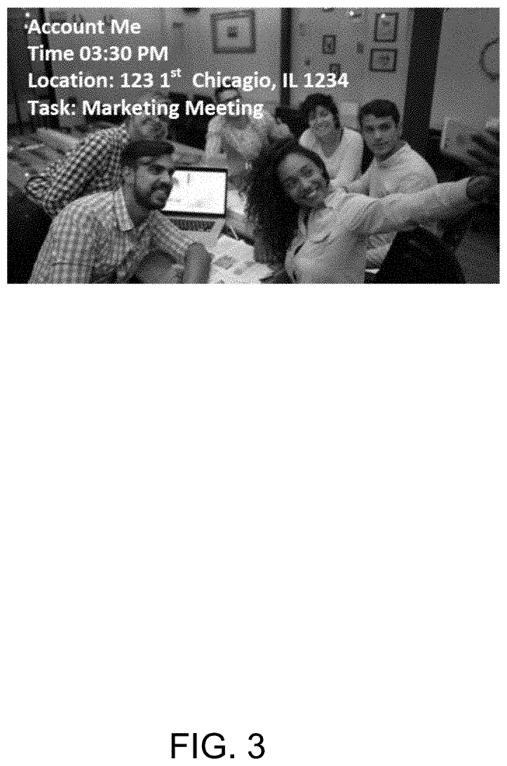

FIG. 3 shows another exemplary embodiment for an addiction accountability group. In this particular instance, the addiction addressed is alcohol addiction, with an accountability group set up around periodic breathalzyer tests as the task(s) for the group members. The system may be used for other forms of addiction, such as, but not limited to, drug addiction. As shown, an originating user creates and saves a task with a randomly recurring specific task component, and sends notifications to the group members 210. The group members view the task, and notification is then sent back to the originating user from the group members indicating that each has viewed the task 220. The system or application then randomly during a period of time (e.g., each week) sends a specific accountability task to the group members 230 (with confirmation of receipt sent back to the originating user 240). The specific accountability task, in this case, is for each group member to take a breathalyzer test within a period of time. The group member takes the breathalyzer test within the time period, then takes a selfie 252 (with zip code or other location indicia, a time stamp, and the breathalyzer results) 250, and sends it to the originating user 260 (who typically would be a group facilitator or organizer). In some embodiments with mutual accountability, the selfie with other information may be sent to some or all other members of the group.

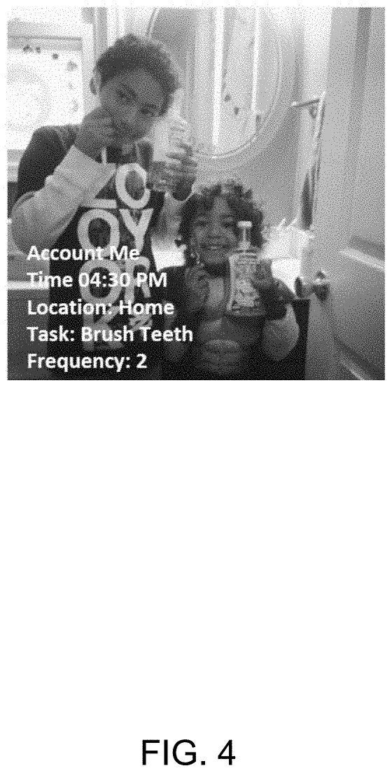

FIG. 4 shows another exemplary embodiment for a court-ordered accountability group, such as for individuals with a DUI (driving under the influence of drugs or alcohol).violation or conviction. An officer of the court, a probation or corrections officer, or the like, acts as the originating user who creates and saves a task with a randomly recurring specific task component, and sends notifications to the group members 310. The group members view the task, and notification is then sent back to the originating user from the group members indicating that each has viewed the task 320. The system or application then randomly during a period of time (e.g., two times a day) sends a specific accountability task to the group members 330 (with a confirmation of receipt, which may be time stamped, sent back to the originating user 340). The specific accountability task, in this case, is for each group member to take a breathalyzer test using a short-range breathalyzer device within a period of time. The group member takes the breathalyzer test within the time period, then takes a self-video of themselves using the breathalyzer 352 (with zip code or other location indicia, a time stamp, a time stamp, and the breathalyzer results) 350, and sends it to the originating user 360 (who typically would be a group facilitator or organizer). If the blood alcohol content (BAC) is 0.0, no further action is required. If the BAC is 0.01 or greater, messages are automatically created and sent to the originating user and the group member notifying them of a violation, and further action may be required.

FIG. 5 shows an exemplary embodiment for a fitness and health accountability group. A group leader, coach, team captain, or the like, acts as the originating user who creates and saves a task with a randomly recurring specific task component, and sends notifications to the group members 410. The group members view the task, and notification is then sent back to the originating user from the group members indicating that each has viewed the task 420. The system or application then creates a check list for completing a certain specific task (e.g., completing a workout) with a certain periodicity (e.g., 4 times a week) 430. The system application then send the checklist task to the group members, with a confirmation of view by each group member and receipt, which may be time stamped, sent back to the originating user 440. The group members then take selfies of themselves working out and logs it with the system application (with location, date, time, occurrence/frequency for that workout, and remaining workouts for the week) 450. Any group member can view all of the selfies and status information for all other group members at any time using the system application. Once a group member has completed the required number of workouts (accountability tasks), a task completion notification for that group member is sent to all group members.

As indicated, the system application of the present invention may be loaded and operable on one or more system servers on a network, such as the Internet. Each use or group member can download and operate a user application program on their mobile device (e.g., tablet, cell phone, or the like) or other computing device that typically are in wireless (or sometimes wired) communication with a network. The application program uses the camera in the mobile device or computing device to take the pictures and or videos, and the application program pulls data from other services in the mobile device or computing device to add to the picture or video (e.g., date and time from the clock and calendar functions, location from the mapping or GPS functions, messages and texts from the messaging/text functions).

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for accountability tracking, comprising the steps of:
receiving, over a network, first task information created by a first user;
automatically transmitting, over the network, said first task information to a second user for viewing on a second user mobile computing device, wherein the first task information comprises a specific task to be completed, an accountability or frequency level, and a type of completion proof required;
receiving, over the network, a first time-stamped read receipt from the second user mobile computing device when the first task information is viewed by the second user;
automatically transmitting, over the network, said first time-stamped read receipt to the first user; and
receiving, over the network, a completion proof message from the second user, wherein the completion proof message establishes that the specific task was completed by the second user, and conforms to the type of completion proof required.

2. The method of claim 1, further comprising the steps of:
automatically transmitting, over the network, the completion proof message to the first user for viewing on a first user mobile computing device;
receiving, over the network, a second time-stamped read receipt from the first user mobile computing device when the completion proof message is viewed by the first user; and
automatically transmitting, over the network, said second time-stamped read receipt to the second user.

3. The method of claim 1, wherein the type of completion proof required comprises a picture and/or video of the second user carrying out or completing the specific task.

4. The method of claim 1, wherein the type of completion proof required comprises a time stamp.

5. The method of claim 1, wherein the type of completion proof required comprises a date stamp.

6. The method of claim 1, wherein the type of completion proof required comprises a location indicator.

7. The method of claim 1, wherein the type of completion proof required comprises breathalyzer data.

8. The method of claim 1, wherein the completion proof message comprises a picture or video, a time stamp, a location, a task description, a frequency indicator, and a text message from the second user.

9. The method of claim 1, wherein the specific task comprises one or more of: walking a pet or pets; feeding a pet or pets; taking out the trash; brushing teeth; or accomplishing a household chore.

10. The method of claim 1, wherein the specific task comprises taking a breathalyzer test.

11. The method of claim 1, wherein the accountability or frequency level comprises one or more of the following: once; at a specific time recurring hourly; recurring daily; recurring weekly; recurring monthly; recurring randomly with a time period; and/or randomly occurring once.

12. A method for accountability tracking, comprising the steps of:
receiving, over a network, first task information created by a first user;
automatically transmitting, over the network, said first task information to a group of second users for viewing by each of said group of second users on a corresponding second user mobile computing device, wherein the first task information comprises a specific task to be completed, an accountability or frequency level, and a type of completion proof required;
receiving, over the network, a first time-stamped read receipt from each of the corresponding second user mobile computing devices when the first task information is viewed by the corresponding second user;
automatically transmitting, over the network, each said first time-stamped read receipt to the first user; and
receiving, over the network, from a particular second user in the group of second users, a completion proof message from the particular second user, wherein the completion proof message establishes that the specific task was completed by the particular second user, and conforms to the type of completion proof required.

13. The method of claim 12, further comprising the step of:
automatically transmitting, over the network, the completion proof message from the particular second user to the first user and/or the group of second users for viewing on a corresponding first user mobile computing device or corresponding second user mobile computing device.
